(19) United States
(12) Patent Application Publication
(10) Pub. No.: US 2015/0026330 A1
(43) Pub. Date: Jan. 22, 2015

(54) GENERATING UNIQUE IDENTIFIERS FOR MOBILE DEVICES

(71) Applicant: CELLCO PARTNERSHIP D/B/A VERIZON WIRELESS, Basking Ridge, NJ (US)

(72) Inventors: Shahid AHMED, Monmouth Junction, NJ (US); Patrick Vito BELLONE, Fanwood, NJ (US); Athar A. MUZAFFAR, Thousand Oaks, CA (US)

(73) Assignee: CELLCO PARTNERSHIP D/B/A VERIZON WIRELESS

(21) Appl. No.: 13/943,655

(22) Filed: Jul. 16, 2013

(51) Int. Cl. H04W 24/04

(52) U.S. Cl. CPC H04W 24/04
USPC 709/224

(57) ABSTRACT

Systems and methods for generating unique identifiers for devices are disclosed. In some implementations, a set of characteristics of a device is received. The set of characteristics identifies an operating system (OS) and a manufacturer of the device. Whether the set of characteristics also includes a first identifier of the device is determined. The first identifier uniquely identifies the device among devices of a same OS and a same manufacturer as the device. Upon determining the set of characteristics includes the first identifier, a unique ID for the device is generated based on the OS of the device, the manufacturer of the device, and the first identifier. Upon determining the set of characteristics lacks the first identifier, a second identifier associated with the device is received. The unique ID is generated based on the OS of the device, the manufacturer of the device, and the second identifier.

### BACKGROUND

Oftentimes, users of mobile devices use the mobile devices to access secure data. For example, an employee of a corporation may use his/her mobile phone or tablet computer to access secure data belonging to the corporation. The corporation may wish to track mobile devices having permission to access the secure data belonging to the corporation or actually accessing the secure data. This tracking may be performed to control access to the secure data or to control which user(s) or device(s) can modify the data. In order to track the mobile devices, the corporation may need to identify the mobile device. However, cellular carriers and mobile device manufacturers do not provide identifiers that are universally applicable to all types of mobile devices and thus the present identifiers are unable to uniquely identify all specific mobile devices.

One possible identifier is a mobile device number (MDN). However, a MDN is assigned to a mobile phone that is currently in use. The MDN may not uniquely identify the mobile phone throughout its life, as the MDN of a mobile phone can be changed, for example, by replacing the subscriber identity module (SIM) card. Also, the MDN may not be used to identify tablet computers or personal digital assistants (PDAs) that are not associated with a telephone number.

Another possible identifier is a media access control (MAC) address used in short-range radio communication technology (e.g., Bluetooth® or WiFi). However, the MAC address can be changed programmatically. Thus, the MAC address cannot be considered unique or reliable to uniquely identify the device.

As the foregoing illustrates, a unique identifier that uniquely identifies a specific mobile device among all mobile devices (e.g., similar to how a Social Security Number uniquely identifies a United States citizen among all United States citizens) may be desirable.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an exemplary system for generating a unique identifier (ID) for a mobile device;

FIG. 2 is a block diagram of an exemplary server shown FIG. 1;

FIG. 3 is a block diagram of an exemplary mobile device shown FIG. 1;

FIG. 4 is a flow chart of an exemplary process for generating a unique ID for the mobile device shown in FIG. 1;

FIG. 5 illustrates an exemplary system for generating a unique ID for the mobile device shown in FIG. 1;

FIG. 6 is a simplified functional block diagram of a computer that may be configured to function as the data store, the server, or the mobile device shown FIG. 1; and

FIG. 7 is a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The instant application relates to a solution for establishing unique IDs for mobile devices. For example, the unique ID uniquely identifies a particular mobile device across all mobile devices created by different manufacturers. Thus, for example, an Apple iPhone® device will not have the same unique ID as a Samsung Android tablet device. In some implementations, a new unique ID for a device (e.g., an alphanumeric string that identifies the device) is created using one of the values available on the device (e.g., a value that identifies the device among other devices having the same manufacturer and operating system). The values selected to be used can be unique for devices having the same operating system and the same manufacturer, but not across all devices having different operating systems and different manufacturers. The unique ID can be used to identify the device for security purposes, for example, the device may be a member of a list of devices (identified by unique IDs) that have permission to access data belonging to a corporation. The unique ID may need to be generated multiple times, for example, if a memory of the mobile device is cleared and the unique ID is deleted. To this end, the approach for selecting the value can be consistent in order to ensure that the same unique ID is generated if the device attempts to generate the unique ID multiple times. Furthermore, in some cases, the techniques described herein create unique IDs for devices that are unique across manufacturers, models, and operating systems using values from the devices that are not unique across manufacturers, models, and operating systems. For example, an Apple iPhone® device cannot have the same unique ID as a Samsung Android tablet device. In addition, the value(s) used in generating the unique ID may be consistently used across a type of devices (or a subset of such devices), such as: all mobile phones produced by the same manufacturer or all mobile phones produced by the same manufacturer and having the same operating system.

According to some examples, to generate the unique ID, a server receives a set of characteristics associated with the mobile device. The set of characteristics may include an operating system associated with the mobile device and a manufacturer associated with the mobile device. The set of characteristics may also include identifier(s) for the mobile device such as, for example, an International Mobile Station Equipment Identity (IMEI) number, a Mobile Equipment Identifier (MEID) number, a unique device identifier (UDID), or a universally unique identifier (UUID). The set of characteristics may be received, for example, from the mobile device or from the manufacturer of the mobile device. In some cases, the server receives the set of characteristics from the mobile device when the mobile device registers to access data associated with the server (e.g., private data belonging to a corporation of which the user of the mobile device is an employee). In some cases, the server receives the set of characteristics from the manufacturer at a manufacture time of the mobile device. Upon receiving the set of characteristics, the server may select a first identifier in the set of characteristics of the mobile device.

The first identifier may uniquely identify the mobile device among all mobile devices having the same operating system and manufacturer as the mobile device. For example, the first identifier may uniquely identify the mobile device among all devices manufactured by Motorola and running the Android operating system. However, two or more mobile devices having different operating systems or different manufacturers (e.g., a Motorola device running the Android operating system and an Apple device running the iOS® operating system) may have the same first identifier. The first identifier can be selected based on the manufacturer and/or the operating system of the mobile device. For example, if the mobile device has an iOS® operating system, the first identifier corresponds to the UDID, if that is available. If the UDID is not available (e.g., not provided by the iOS® operating system of the mobile device), the first identifier corresponds to the serial number. If the serial number and the UDID are both unavailable, the first identifier corresponds to the UUID. To illustrate further, if the mobile device has an Android operating system, the first identifier may be selected sequentially and based on availability according to the following list, where items earlier in the list are used if they are available and items later in the list are used if the earlier items are not available: (1) MEID, (2) IMEI, (3) serial number if the OS version is 2.3 or larger, and (4) Android ID. If the mobile device has a Windows Phone 8® operating system, the Windows Phone 8® ID may be used as the first identifier if available. If the mobile device has a Blackberry® operating system, the MEID or IMEI may be used as the first identifier if available.

In some examples, the above orders of first identifiers for various operating systems are selected based on reliability of the first identifier values. MEID and IMEI are very reliable since the cellular networks also rely on these values. Thus, the MEID and IMEI are unique across manufacturers as well. Serial number are the next most reliable, after removing known bad serial numbers from the list. Also, an application programming interface (API) is not always available to retrieve the serial number, so other approaches, which are not always reliable, are used to retrieve the serial number. Thus, the MEID or IMEI may be used, if available. In some cases, a manufacturer may create the same Android ID for all devices of a specific model. A software update can be used to provide different Android IDs to the devices of the specific model. However, reliability of the Android ID is reduced. Also, Android devices may sometimes change their Android IDs, further reducing reliability of the Android ID for generating the unique ID. In some implementations, the above orders of first identifiers for various operating systems are selected based on a likelihood that the operating system stores the particular first identifier value, with more likely-to-be-stored first identifier values appearing earlier in the order and, thus, being more likely to be used.

If none of the above candidate first identifiers is available, a second identifier for the mobile device may be used in place of the first identifier. The second identifier may be generated in the mobile device. The second identifier may be generated, for example, via an application executing on the mobile device or via the operating system of the mobile device. For example, some devices running iOS® operating systems are configured to generate a UDID. For example, a mobile device can generate a second identifier for the mobile device (e.g., a device running iOS® can generate a UDID) by generating a string corresponding to the second identifier and checking, in a data repository, whether the string has been assigned to another device having the same manufacturer and operating system. If the string has already been assigned, the mobile device generates another string, or multiple other strings, until the mobile device generates a string that has not been assigned. When a string corresponding to the second identifier that has not yet been assigned to another device is generated, the string is stored, at the mobile device, as the second identifier.

A unique ID for the mobile device is generated based on the operating system of the mobile device, the manufacturer of the mobile device, and the first or second identifier. According to some examples, the unique ID is generated by combining the following values: (1) a single character for the operating system (e.g., ‘I’ for iOS or ‘A’ for Android), (2) three characters for the manufacturer (e.g., “APP” for Apple, “HTC” for HTC, “LG_” for LG, or “MOT” for Motorola), (3) a single character for the type of identifier used. For example, for the first identifier ‘M’ may be used as the single character to reflect MEID is used for the first identifier. Alternatively, ‘I’ may be used as the single character to reflect IMEI is used for the first identifier. Alternatively, ‘U’ may be used as the single character to reflect a unique value given by the mobile operating system is used for the first identifier such as, for example, UDID in iOS®. Alternatively, S’ may be used as the single character to reflect serial number is used as the first identifier. For the second identifier, ‘G’ may be used as the single character to reflect generated value or second identifier being used.

For example, an Apple iPhone® running an iOS® operating system having a UDID of “H2NX4” will have a unique ID of: “IAPPUH2NX4,” where: ‘I’ corresponds to the iOS® operating system, “APP” corresponds to Apple being the manufacturer, ‘U’ indicates that the UDID was used as the second identifier, and “H2NX4” is the UDID. It should be noted that a UDID may, in some cases, be longer than the example five-character UDID provided above.

Moving forward, after generating the unique ID, the server stores the unique ID in the server's associated memory or data storage. The server may also forward the unique ID to the mobile device for storage at the mobile device. At the mobile device, the unique ID may be stored in a unit of the memory that cannot be modified by a user of the mobile device. This may prevent the user from tampering with the unique ID. The mobile device may register with the server (e.g., to access data or a service associated with the server) using the unique ID associated with the mobile device.

In some examples, the mobile device can generate a long random string or a long random number, with a very low probability of overlap, as the unique ID. The long random string or long random number can be generated by the manufacturer at manufacture time for newly manufactured devices, but may not be able to be added to legacy devices. Furthermore, even for newly manufactured devices, using such a long random string or long random number would require agreement, among different manufacturers and different developers of mobile operating systems regarding the characteristics of the long random string or the long random number and the process to generate the long random string or the long random number. Such an agreement may be difficult to achieve and would require developing a new standard. In addition, the long random string may not be able to be re-generated if the long random string is removed from memory, as the long random string is random. Some of the techniques for generating the unique ID described herein do not require a standard for the unique ID that is agreed upon by different manufacturers or different developers of mobile operating systems and can be used on legacy devices. For example, as set forth above, using the techniques described herein different unique IDs can be generated for a legacy Apple® device with an iOS® operating system and a legacy Samsung® device with an Android operating system.

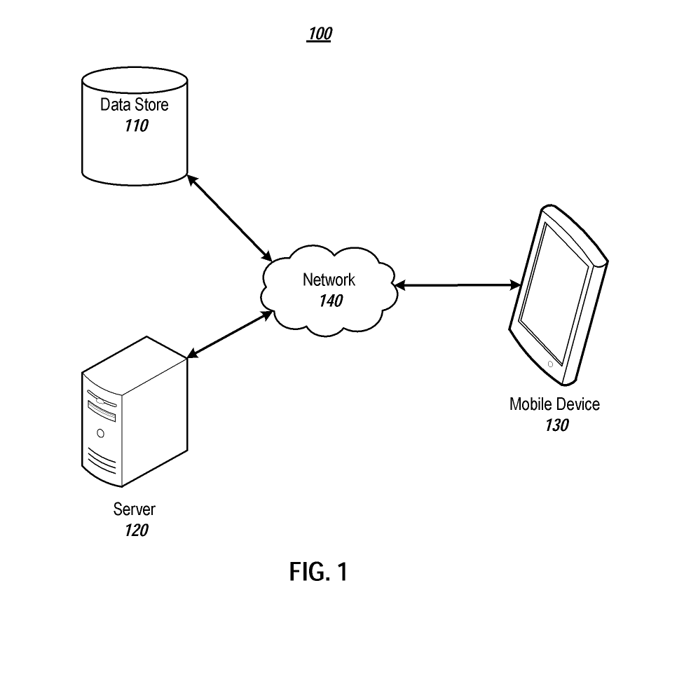

With this overview, the solution for establishing unique identifiers for mobile devices will be described in more details with respect to the figures of the instant application. FIG. 1 illustrates an exemplary system 100 for generating a unique identifier for a mobile device. As shown, the system 100 includes a data store 110, a server 120, and a mobile device 130. While a single data store 110, a single server 120, and a single mobile device 130 are illustrated in FIG. 1, the subject technology can be implemented with multiple data stores, servers, and/or mobile devices. Also, while the data store 110, server 120, and mobile device 130 are illustrated as separate machines, in some examples, a single machine can implement the functions of two or more of the data store 110, the server 120, or the mobile device 130. In some implementations, the data store 110 or the server 120 can be split into multiple distinct machines.

The data store 110, the server 120, and the mobile device 130 may communicate with one another via a network 140. The network 140 may include one or more of the Internet, an intranet, a wired network, a wireless network, a local area network, a wide area network, a cellular network, a virtual private network (VPN), etc. The network 140 may include a single network or multiple interconnected networks.

The data store 110 stores data. The stored data may include unique identifier(s) ID(s) generated for mobile device(s) (e.g., mobile device 130) using the techniques described herein. The stored data may also include a name of the user associated with the mobile device, another identifier associated with the mobile device, a log of activity associated with the mobile device, etc.

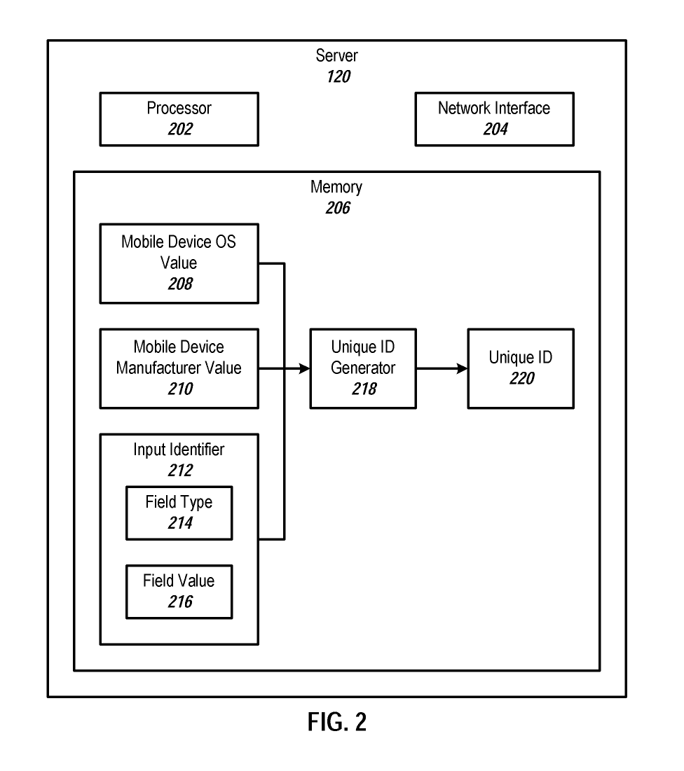

The server 120 may be implemented as a single processor machine, a multiprocessor machine, or as a server farm including multiple machines each having one or more processors. The server 120 stores, among other things, code to generate a unique identifier (ID) for a mobile device (e.g., mobile device 130). Example structure(s) and operation(s) of the server 120 are described in more detail in conjunction with FIG. 2, below.

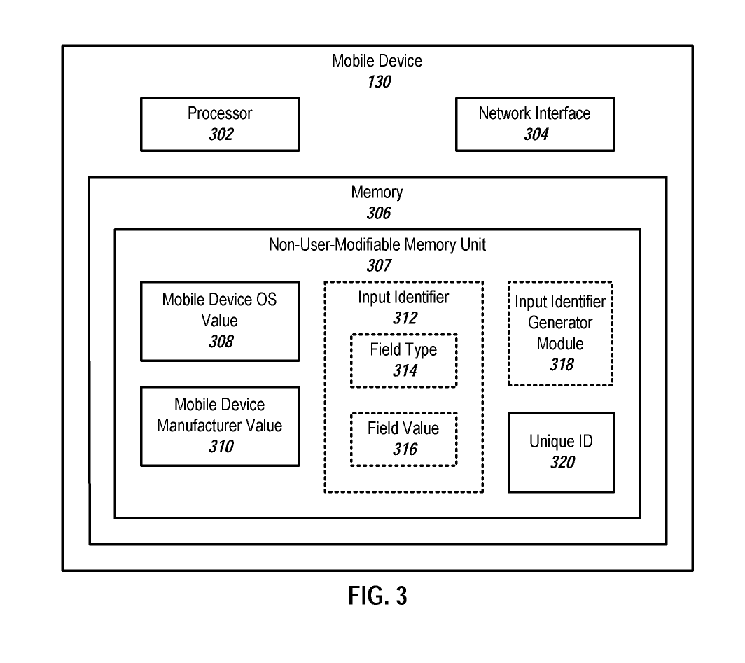

The mobile device 130 may be a mobile phone, a digital music player, a personal digital assistant (PDA), a tablet computer, a laptop computer, etc. The mobile device 130 may be associated with a specific operating system and manufacturer. The structure and operation of the mobile device 130 are described in more detail in conjunction with FIG. 3, below.

As illustrated in FIG. 1, the mobile device 130 is assigned a unique ID that, in some cases, uniquely identifies the mobile device 130 among mobile devices associated with different manufacturers or different operating systems. The unique ID for the mobile device 130 may be stored at the mobile device 130 and at the data store 110. The server includes code for generating the unique ID for the mobile device 130.

FIG. 2 is a block diagram of an exemplary server 120 shown in FIG. 1. The server 120 includes a processor 202, a network interface 204, and a memory 206. The processor 202 is configured to execute instructions stored in a machine-readable medium such as, for example, the memory 206. While a single processor 202 is illustrated, the server 120 may include a single processor 202 or multiple processors 202. The network interface 204 includes an interface for transmitting and/or receiving data in a network such as, for example, the network 140 of FIG. 1. The network interface 204 can include one or more network interface cards (NICs). The memory 206 includes data or instructions. As shown, the memory 206 stores a mobile device operating system (OS) value 208, a mobile device manufacturer value 210, an input identifier 212, a unique ID generator 218, and a unique ID 220.

The mobile device OS value 208, the mobile device manufacturer value 210, and the input identifier 212 may be received at the server 120 from the mobile device 130. The mobile device OS value 208 represents an operating system (e.g., Android or iOS®) associated with the mobile device 130. In one specific example, the mobile device OS value 208 is represented with a single character such as, for example: ‘I’ for iOS®, ‘A’ for Android, ‘B’ for Blackberry®, or ‘W’ for Windows® Phone.

The mobile device manufacturer value 210 represents a manufacturer (e.g., Motorola or Apple) associated with the mobile device 130. According to some examples, the mobile device manufacturer value 210 is represented with three characters, with underscores (‘_’) being used if the manufacturer name includes fewer than three characters. Examples of the mobile device manufacturer value 210 are as follows: “APP” for Apple®, “BLA” for Blackberry®, “CAS” for Casio®, “HTC” for HTC®, “LG_” for LG®, “MOT” for Motorola®, “PAN” for Pantech®, “SAM” for Samsung®, “SON” for Sony Ericsson®, or “ZTE” for ZTE®.

The input identifier 212 is a value associated with the mobile device 130. The input identifier 212 may uniquely identify the mobile device 130 among mobile devices having the same operating system and the same manufacturer. For example, the input identifier 212 may include an International Mobile Station Equipment Identity (IMEI) number, a Mobile Equipment Identifier (MEID) number, a unique device identifier (UDID), a universally unique identifier (UUID), or a serial number assigned by the manufacturer. Alternatively or additionally, the input identifier 212 may be generated by an application on the mobile device 130. In some examples, the input identifier 212 that is generated by the server or by the application on the mobile device is randomly generated. The randomly generated input identifier 212 may be used as a last resort, if other identifiers are not available, as the randomly generated input identifier 212 may not be able to be regenerated in a case where the memory of the mobile device is reset, unlike some other input identifiers discussed herein. The application for generating the input identifier 212 can be loaded onto the mobile device over the network 140, using an installation disk, or by connecting the device to a laptop or desktop computer that stores the software code for the application. The application for generating the input identifier 212 can be the same application across manufacturers and/or operating systems, or each manufacturer and/or operating system can have its own application for generating the input identifier 212. Thus, in various embodiments, the input identifier 212 may be associated only with the device characteristics, only generated by the application or a combination thereof. For example, the mobile device 130 can generate the input identifier 212 by generating a string corresponding to the input identifier 212 and checking, in a data repository, whether the string has been assigned to another device having the same manufacturer and operating system as the mobile device 130 and/or to any other device regardless of manufacturer or operating system. If the input identifier is only determined by generation and the string has already been assigned, the mobile device 130 generates another string, or multiple other strings, until the mobile device 130 generates a string that has not been assigned. When a string corresponding to the input identifier 212 that has not yet been assigned to another device is generated, the string is stored as the input identifier 212 and provided to the server 120.

The input identifier 212 includes a field type 214 and a field value 216. The field type 214 represents the field type of the input identifier such as, for example, IMEI, MEID, UDID, or UUID. The field value 216 represents the value of the field type 214 for the mobile device 130. To illustrate, if IMEI is “1XZ49,” then the field type 214 is IMEI and the field value 216 is “1XZ49.” The field type 214 may be represented as a single character. The single character may be: ‘M’ for MEID, ‘I’ for IMEI, ‘U’ for unique device ID provided by the mobile operating system, such as the UDID in iOS® or the Windows® Device ID in Windows® Phone, ‘S’ for serial number, or ‘G’ for application-generated value.

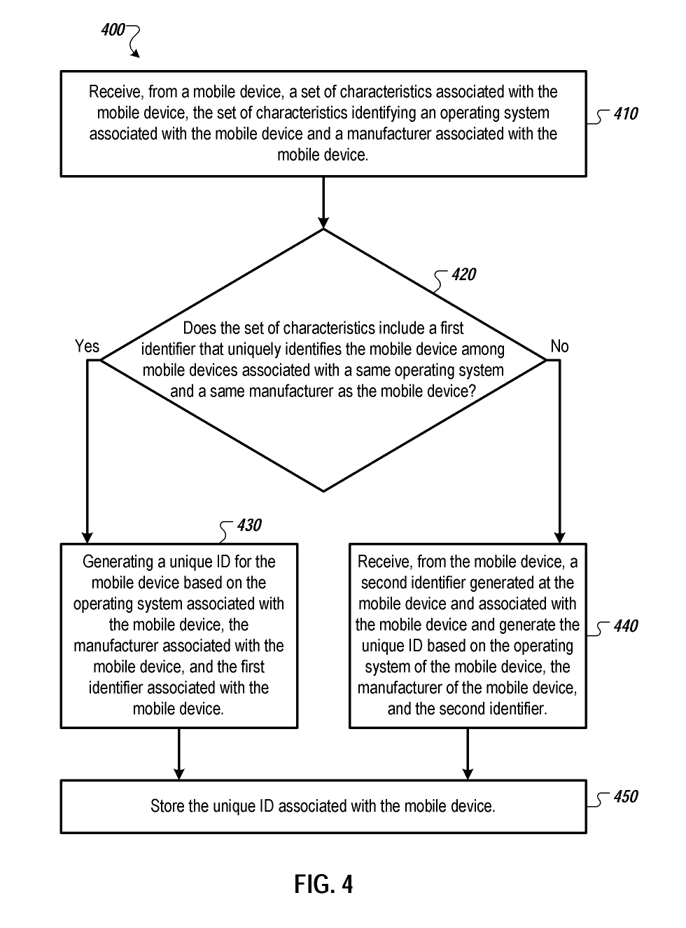

The unique ID generator 218 includes code for receiving the mobile device OS value 208, the mobile device manufacturer value 210, and the input identifier 212 from the mobile device 130. The unique ID generator 218 includes code for combining the mobile device OS value 208, the mobile device manufacturer value 210, and the input identifier 212 to generate the unique ID 220 associated with the mobile device 130. The mobile device OS value 208, the mobile device manufacturer value 210, and the input identifier 212 can be combined according to the order specified above or according to any other order. However, in some cases, the same order is used each time the unique ID generator 218 operates to ensure that the same unique ID for a specified mobile device is generated each time the unique ID generator 218 is executed. In some examples, the unique ID generator 218 operates by combining strings from the mobile device OS value 208, the mobile device manufacturer value 210, and the input identifier 212. Alternatively, the unique ID generator 218 can operate by combining the mobile device OS value 297 with the input identifier 212 or the mobile device manufacturer value 210 with the input identifier 212. The resulting unique ID 220 may be an alphanumeric string. For example, if the mobile device OS value 208 is ‘I’ for iOS®, the mobile device manufacturer value 210 is “APP” for Apple®, the field type 214 is ‘U’ for UDID, and the field value 216 is “AB12C,” the unique ID 220 can be “IAPPUAB12C,” corresponding to a combination of the above strings according to the order: (1) mobile device OS value 208, (2) mobile device manufacturer value 210, (3) field type 214, (4) field value 216. The unique ID generator 218 is described in more details below with respect to FIG. 4.

The UDID may be used as the first identifier to generate the unique ID for an iOS® mobile device. For example, the unique ID may include ‘IAPPUACF569370BB6AEFC202DB48FD3543CB3,’ where ‘I’ represents that iOS is the operating system, ‘APP’ represents that Apple is the manufacturer; ‘U’ indicates that the UDID was used. ‘ACF569370BB6AEFC202DB48FD3543CB3’ is the UDID of the device. Alternatively, the serial number may be used as the first identifier to generate the unique ID for an iOS® mobile device. For example, the unique ID may include ‘IAPPSDLXGP0P2DFHW’, where ‘I’ represents that iOS® is the operating system, ‘APP’ represents that Apple is the manufacturer; ‘S’ indicates that the serial number was used. ‘DLXGP0P2DFHW’ is the Serial Number of the device. Alternatively, the iOS® UUID may be used as the first identifier to generate the unique ID for an iOS® mobile device. For example, the unique ID may include ‘IAPPGCB67256BE8F314743B73D2E96E62D504FECC5E75’ is, where ‘I’ represents that iOS is the operating system; ‘APP’ represents that Apple is the manufacturer; ‘G’ indicates that the iOS® generated value was used. ‘CB67256BE8F314743B73D2E96E62D504FECC5E75’ is the generated value for the device

The MEID may be used as the first identifier to generate the unique ID on a Motorola Device. For example, the unique ID for the Motorola device may include ‘AMOTMA0000015DD271B’, where ‘A’ represents Android as the operating system; ‘MOT’ represents Motorola as the manufacturer; ‘M’ represents that the MEID was used. ‘A0000015DD271B’ is the MEID of the device. The serial number may be used as the first identifier to generate the unique ID on a Samsung device. For example, the unique ID for the Samsung device may include ‘ASAMS0149A91D1901101A’, where ‘A’ represents Android as the operating system; ‘SAM’ represents Samsung as the manufacturer; ‘S’ represents that the Serial Number was used. ‘0149A91D1901101A’ is the serial number of the device.

The Android ID may be used as the first identifier to generate the unique ID on a HTC device. For example, the unique ID for the HTC device may include ‘AHTCG22A100001350E542’, where ‘A’ represents Android as the operating system; ‘HTC’ represents HTC as the manufacturer; ‘G’ represents that the Android generated value was used. ‘22A100001350E542’ is the Android generated value for the device.

FIG. 3 is a block diagram of an example of the mobile device 130 of FIG. 1. As shown, the mobile device 130 includes a processor 302, a network interface 304, and a memory 306. The processor 302 is configured to execute instructions stored in a machine-readable medium, for example, the memory 306. While a single processor 302 is illustrated, the mobile device 130 may include a single processor 302 or multiple processors 302. The network interface 304 includes an interface for transmitting and/or receiving data in a network, for example, the network 140 of FIG. 1. The network interface 304 can include one or more network interface cards (NICs). The memory 306 includes data or instructions. As shown, the memory 306 includes a non-user-modifiable memory unit 307.

The non-user-modifiable memory unit 307 includes data and/or instructions that are stored on the mobile device 130 but cannot be modified by a user of the mobile device 130, thus ensuring the security and integrity of the stored data and/or instructions in the non-user-modifiable memory unit 307. As shown, the non-user-modifiable memory unit 307 stores a mobile device OS value 308, a mobile device manufacturer value 310, and the unique ID 320. Optionally, the non-user-modifiable memory unit also stores an input identifier 312 and/or an input identifier generator module 318.

The mobile device OS value 308 represents an operating system of the mobile device 130 that is provided to the server 120 to generate the unique ID 320. The mobile device OS value 308 corresponds to the mobile device OS value 208 stored at the server 120. Similarly, the mobile device manufacturer value 310 represents a manufacturer of the mobile device 130 that is provided to the server 120 to generate the unique ID 320. The mobile device manufacturer value 310 corresponds to the mobile device manufacturer value 310 stored at the server 120. In some examples, the unique ID 320 corresponds to a value that uniquely identifies the mobile device 130 among all mobile devices having any operating system or manufacturer. The unique ID 320 may be generated at the server 120 and received at the mobile device 130 from the server 120. The unique ID 320 may correspond to the unique ID 220 stored at the server.

As shown, the input identifier 312 at the mobile device 130 corresponds to the input identifier 212 at the server 120, as, in some examples, the mobile device 130 provides the input identifier 312 to the server 120. Similarly to the input identifier 212, the input identifier 312 includes a field type 314 and a field value 316 that store information similar to the field type 214 and the field value 216 of the input identifier 212 at the server 120.

Some mobile device operating systems or manufacturers may not provide an input identifier. In such circumstances, the mobile device 130 may include an input identifier generator module 318 that generates the input identifier 312 for the mobile device 130. The identifier generated by the input identifier generator module 318 may uniquely identify the mobile device 130 among all devices having the same operating system and the same manufacturer as the mobile device 130.

As illustrated in FIG. 3, the input identifier 312 and the input identifier generator module 318 are optional components of the memory 306 of the mobile device 130. In some examples, the mobile device 130 may be implemented without at least one of the input identifier 312 or the input identifier generator module 318. For example, the input identifier generator module 318 may be useful when the memory 306 lacks the input identifier 312. Alternatively, the memory 306 may store the input identifier 312 and lack the input identifier generator module 318.

FIG. 4 is a flow chart of an example process 400 for generating a unique identifier for a mobile device. The process 400 can be initiated, for example, when a cellular carrier is installing software on a mobile device to prepare the mobile device for provision to a customer or by a mobile device requesting an identifier to register with a server to access secure data (e.g., an employee registering a mobile device to access secure data belonging to a corporation) some time (e.g., several days, weeks, or months) after the mobile device has been manufactured, activated by the service provider, and provided to the user. Alternatively, the process 400 can be initiated at the factory of the manufacturer, while the mobile device is being manufactured, or at a store of the service provider, when the mobile device is being provided to the user or prepared for provision to the user. The mobile device can be registered with the server using the unique ID associated with the mobile device, generated according to the process 400.

The process 400 begins at step 410, where a server (e.g., server 120, via operation of unique ID generator 218) receives, from a mobile device (e.g., mobile device 130) or, in some cases, from a manufacturer or service provider of the mobile device, a set of characteristics (e.g., mobile device OS value 208, mobile device manufacturer value 210, and/or input identifier 212) associated with the mobile device. The set of characteristics identifies an operating system associated with the mobile device (e.g., Android) and a manufacturer associated with the mobile device (e.g., Motorola). Optionally, the set of characteristics may include one or more identifiers of the mobile device that are generated or stored at the mobile device. The mobile device and the server can communicate via a network (e.g., network 140).

In step 420, the server determines whether the set of characteristics includes a first identifier (e.g., input identifier 212) that uniquely identifies the mobile device among mobile devices associated with the same operating system and the same manufacturer as the mobile device. For example, if the mobile device is manufactured by HTC and has a Windows Phone® operating system, the server determines whether the set of characteristics includes a the first identifier that uniquely identifies the mobile device among all HTC mobile devices running the Windows Phone® operating system. In some examples, multiple identifiers are available to the mobile device, each of which uniquely identifies the mobile device among mobile devices associated with the same operating system and the same manufacturer as the mobile device. In such circumstances, the server can select the first identifier from among the multiple available identifiers based on an order for the multiple available identifiers. The order may be stored at the server or in a data repository coupled with the server. The order can be based on the operating system of the mobile device. For example, for iOS® the order can be: (1) UDID, (2) serial number, (3) UUID. If the set of characteristics includes the first identifier, the process 400 continues to step 430. If the set of characteristics does not include the first identifier, the process 400 continues to step 440.

In step 430, if the set of characteristics includes the first identifier, the server generates a unique ID (e.g., unique ID 220) for the mobile device based on the operating system associated with the mobile device, the manufacturer associated with the mobile device, and the first identifier associated with the mobile device. After step 430, the process 400 continues to step 450.

In step 440, if the set of characteristics does not include the first identifier, the server receives, from the mobile device, a second identifier generated at the mobile device (e.g., via operation of the input identifier generator module 318) and associated with the mobile device. After reviewing the set of characteristics and not finding the first identifier, the server can provide a prompt, to the mobile device, to generate the second identifier. The mobile device may not have initially provided the second identifier because the second identifier is not one of the stored device characteristics that the mobile device provides when prompted for its characteristics. Alternatively, the second identifier may be generated at the server, rather than at the mobile device. In some examples, the second identifier is generated at a machine different from the mobile device and different from the server. The second identifier uniquely identifies the mobile device among all devices having the same operating system and manufacturer as the mobile device. The server generates the unique ID based on the operating system of the mobile device, the manufacturer of the mobile device, and the second identifier.

In step 450, the server stores the unique ID associated with the mobile device. The unique ID associated with the mobile device can be stored at the server (e.g., as unique ID 220 in the memory 206) or in a data store (e.g., data store 110) coupled with the server. The server can transmit the unique ID to the mobile device for storing in a memory at the mobile device (e.g., as unique ID 320 in the memory 306). The server can signal the mobile device to store the unique ID associated with the mobile device in a unit of the local memory of the mobile device that is not modifiable by a user of the mobile device without uninstalling the operating system of the mobile device (e.g., non-user-modifiable memory unit 307). The mobile device can use the unique ID to identify itself. For example, the mobile device can use the unique ID to register to access a server or data repository storing private or sensitive data (e.g., data of a corporation of which the user of the mobile device is an employee). In some examples, if permitted by privacy laws of a jurisdiction where the mobile device is used, the carrier of the mobile device can use the unique ID to track actions the user takes on the mobile device (e.g., removing a SIM lock, changing a mobile device number, etc.). The mobile device can forward the unique ID to the server so that the server can access information related to the mobile device or verify that the mobile device has permission to access certain data. After step 450, the process 400 ends.

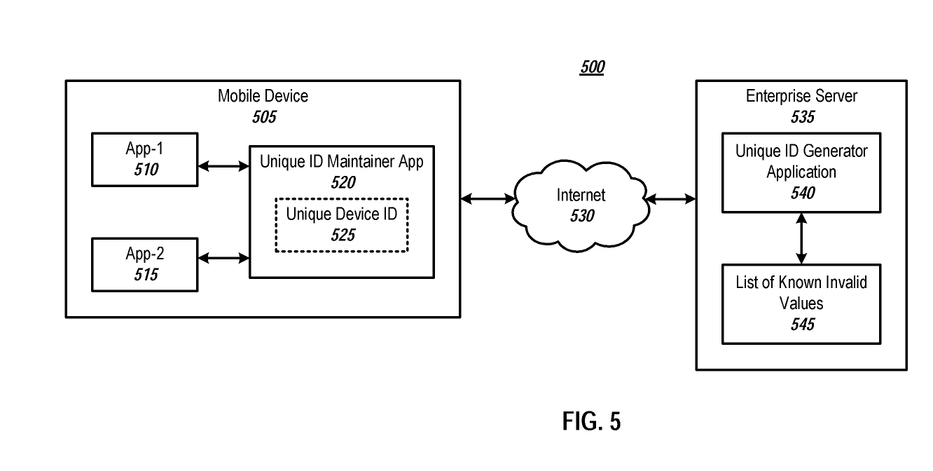

FIG. 5 illustrates an example system 500 for generating a unique device identifier. As shown, the system 500 includes a mobile device 505 connected to an enterprise server 535 over the Internet 530. The mobile device 505 can correspond to an example of the mobile device 130. The enterprise server 535 can correspond to an example of the server 120. The Internet 535 can correspond to an example of the network 140.

The mobile device 505 includes App-1 510, App-2 515, and a unique ID maintainer app 520. The unique ID maintainer app 520 stores, in some examples, a unique device ID 525. The enterprise server 535 includes a unique ID generator application 540 and a list of known invalid values 545.

During operation, the mobile device 505 launches App-1 510, a native application. App-1 510 checks the unique ID maintainer app 520 to determine whether the unique device ID 525 is stored at the mobile device 505.

Upon determining that no unique device ID 525 is stored at the mobile device 505, the unique ID maintainer app 520 gathers information (e.g., operating system information, manufacturer information, and available identifying values of the mobile device 505) from the mobile device 505 to send to the enterprise server 535 for generating the unique device ID 525 for the mobile device 505 at the enterprise server 535. The gathered information is sent from the mobile device 505 to the enterprise server 535.

At the enterprise server 535, the unique ID generator application 540 uses the list of known invalid values 545 to cross-check the gathered values from the mobile device 505 to ensure that only valid values are used to generate the unique device ID 525. Once the gathered values are validated, the unique ID generator application 540 generates the unique device ID 525 and sends the unique device ID 525 to the mobile device 505 or storage, at the mobile device 505, using the unique ID maintainer app 520. The unique device ID 525 is stored at the mobile device 505 for use with future requests for the unique device ID 525. The unique device ID 525 is provided to App-1 510 so that the unique device ID 525 can be used by App-1 510 as the unique identifier for the device.

App-2 515, another native application, is launched at the mobile device 505. Upon launch, App-2 515 checks with the unique ID maintainer app 520 to determine whether the unique device ID 525 is stored at the mobile device 505. If the unique device ID 525 is stored at the mobile device 505, the unique device ID 525 is provided to App-2 515 for processing using App-2 515.

As shown by the above discussion, functions relating to generating unique identifier(s) for mobile device(s) may be implemented on computers connected for data communication via the components of a packet data network. Although special purpose devices may be used, such devices also may be implemented using one or more hardware platforms intended to represent a general class of data processing device commonly used to run programming so as to implement the functions discussed above.

As known in the mobile communications field, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g., files used for the content media editing. The software code is executable by the general-purpose computer that functions as the data store 110, the server 120, the mobile device 130, the mobile device 505, and/or the enterprise server 535. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for allowing the user to edit media content to an acceptable size for successful transmission over the network, in essentially the manner performed in the implementations discussed and illustrated herein.

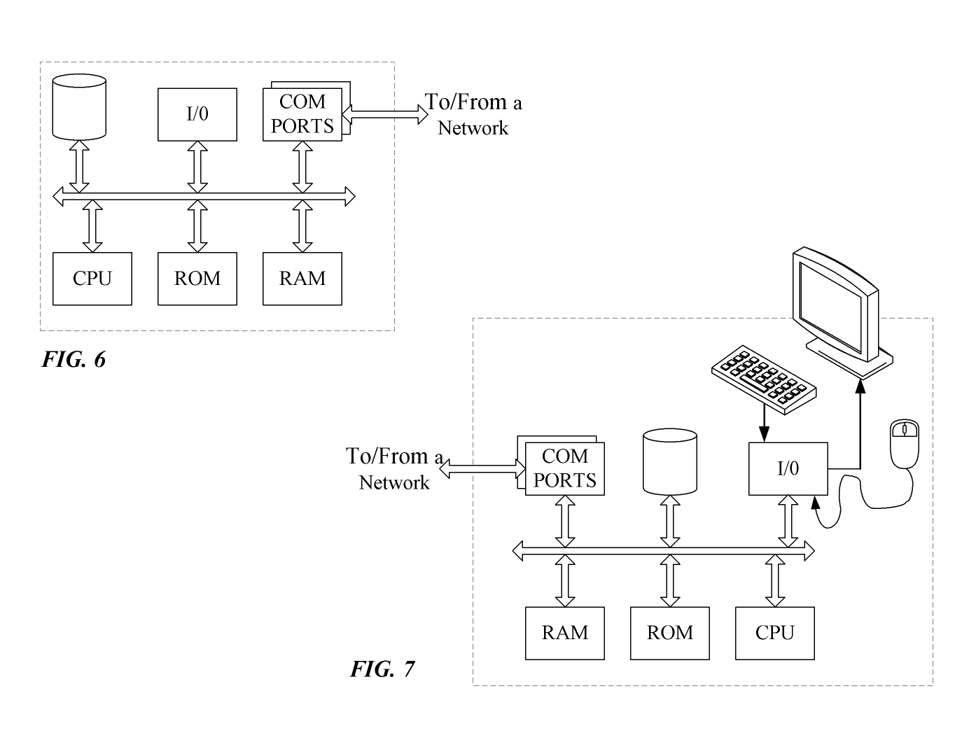

FIGS. 6 and 7 provide functional block diagram illustrations of general purpose computer hardware platforms. FIG. 6 illustrates a network or host computer platform, as may typically be used to implement a server. FIG. 7 depicts a computer with user interface elements, as may be used to implement a personal computer or other type of work station or terminal device, although the computer of FIG. 7 may also act as a server if appropriately programmed. It is believed that the general structure and general operation of such equipment as shown in FIGS. 6 and 7 should be self-explanatory from the high-level illustrations.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 7). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Hence, examples of the methods of managing information about content transmission outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the application(s) 150, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

In some aspects, the subject technology relates to a method. The method includes receiving, at a server in a mobile communication network, a set of characteristics associated with a mobile device, the set of characteristics identifying an operating system associated with the mobile device and a manufacturer associated with the mobile device. The method includes determining whether the set of characteristics also includes a first identifier associated with the mobile device, the first identifier being an intrinsic or predefined value associated with the mobile device and uniquely identifying the mobile device among mobile devices associated with a same operating system and a same manufacturer as the mobile device. The method includes, upon determining the set of characteristics includes the first identifier, generating a unique identifier (ID) for the mobile device based on the operating system associated with the mobile device, the manufacturer associated with the mobile device, and the first identifier associated with the mobile device. The method includes, upon determining the set of characteristics does not include the first identifier, obtaining a second identifier associated with the mobile device and generating the unique ID based on the operating system of the mobile device, the manufacturer of the mobile device, and the second identifier. The method includes storing the unique ID associated with the mobile device.

In some examples, the method also includes transmitting to the mobile device the unique ID for storage in a local memory of the mobile device.

In some examples, transmission of the unique ID to the mobile device includes signaling the mobile device to store the unique ID in a unit of the local memory of the mobile device that is not modifiable by a user of the mobile device without uninstalling the operating system associated with the mobile device.

In some examples, the unique ID associated with the mobile device comprises: an indication of the operating system associated with the mobile device; an indication of the manufacturer associated with the mobile device; an indication of a field type of the first identifier or the second identifier; and the first identifier or the second identifier. In such embodiments, these indications are explicit, containing at least one alphanumeric character that specifies each separately.

In some examples, the field type is one of a serial number, an International Mobile Station Equipment Identity (IMEI) number, a Mobile Equipment Identifier (MEID) number, a unique device identifier (UDID), or a universally unique identifier (UUID).

In some examples, the method also includes selecting the first identifier from a set of available identifiers of the mobile device based an order for the set of available identifiers, the order being based on the operating system of the mobile device.

In some examples, the method also includes receiving, at the server, a request to access a data store, the request being coupled with the unique ID of the mobile device. The method also includes storing the unique ID in a set of unique IDs permitted to access the data store. The method also includes providing, to the mobile device having the unique ID, permission to access the data store.

In some examples, the method also includes receiving, at the server, a request to register the mobile device with the server; and registering the mobile device with the server using the unique ID associated with the mobile device.

In some examples, the first identifier includes one or more of: a serial number, an International Mobile Station Equipment Identity (IMEI) number, a Mobile Equipment Identifier (MEID) number, or a universally unique identifier (UUID).

In some examples, the second identifier includes an operating system generated value.

In some examples, the operating system generated value includes a unique device identifier (UDID).

These general and specific aspects may be implemented using a system, a method, a computer program, a computer readable medium, or an apparatus or any combination of systems, methods, computer programs, computer readable mediums, and/or apparatuses

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, at a server in a mobile communication network, a set of characteristics associated with a mobile device, the set of characteristics identifying an operating system associated with the mobile device and a manufacturer associated with the mobile device;
determining whether the set of characteristics also includes a first identifier associated with the mobile device, the first identifier being an intrinsic or predefined value associated with the mobile device and uniquely identifying the mobile device among mobile devices associated with a same operating system and a same manufacturer as the mobile device;
upon determining the set of characteristics includes the first identifier, generating a unique identifier (ID) for the mobile device based on the operating system associated with the mobile device, the manufacturer associated with the mobile device, and the first identifier associated with the mobile device;
upon determining the set of characteristics does not include the first identifier, obtaining a second identifier associated with the mobile device and generating the unique ID based on the operating system of the mobile device, the manufacturer of the mobile device, and the second identifier; and
storing the unique ID associated with the mobile device.

2. The method of claim 1, further comprising transmitting to the mobile device the unique ID for storage in a local memory of the mobile device.

3. The method of claim 2, wherein transmission of the unique ID to the mobile device includes signaling the mobile device to store the unique ID in a unit of the local memory of the mobile device that is not modifiable by a user of the mobile device without uninstalling the operating system associated with the mobile device.

4. The method of claim 1, wherein the unique ID associated with the mobile device includes:
an indication of the operating system associated with the mobile device;
an indication of the manufacturer associated with the mobile device;
an indication of a field type of the first identifier or the second identifier; and
the first identifier or the second identifier.

5. The method of claim 4, wherein the field type is one of a serial number, an International Mobile Station Equipment Identity (IMEI) number, a Mobile Equipment Identifier (MEID) number, a unique device identifier (UDID), or a universally unique identifier (UUID).

6. The method of claim 1, further comprising selecting the first identifier from a set of available identifiers of the mobile device based an order for the set of available identifiers, the order being based on the operating system of the mobile device.

7. The method of claim 1, further comprising:
receiving, at the server, a request to access a data store, the request being coupled with the unique ID of the mobile device;
storing the unique ID in a set of unique IDs permitted to access the data store; and
providing, to the mobile device having the unique ID, permission to access the data store.

8. The method of claim 1, further comprising:
receiving, at the server, a request to register the mobile device with the server; and
registering the mobile device with the server using the unique ID associated with the mobile device.

9. The method of claim 1, wherein the first identifier comprises one or more of: a serial number, an International Mobile Station Equipment Identity (IMEI) number, a Mobile Equipment Identifier (MEID) number, or a universally unique identifier (UUID).

10. The method of claim 1, wherein the second identifier comprises an operating system generated value.

11. The method of claim 10, wherein the operating system generated value comprises a unique device identifier (UDID).

12. A non-transitory computer-readable medium storing instructions for one or more computers to:
receive, at a server in a mobile communication network, a set of characteristics associated with a mobile device, the set of characteristics identifying an operating system associated with the mobile device and a manufacturer associated with the mobile device;
determine whether the set of characteristics also includes a first identifier associated with the mobile device, the first identifier being an intrinsic or predefined value associated with the mobile device and uniquely identifying the mobile device among mobile devices associated with a same operating system and a same manufacturer as the mobile device;
upon determining the set of characteristics includes the first identifier, generate a unique identifier (ID) for the mobile device based on the operating system associated with the mobile device, the manufacturer associated with the mobile device, and the first identifier associated with the mobile device;
upon determining the set of characteristics does not include the first identifier, obtain a second identifier generated associated with the mobile device and generating the unique ID based on the operating system of the mobile device, the manufacturer of the mobile device, and the second identifier; and
store the unique ID associated with the mobile device.

13. The computer-readable medium of claim 12, further storing instructions for the one or more computers to transmit to the mobile device the unique ID for storage in a local memory of the mobile device.

14. The computer-readable medium of claim 13, wherein the instructions to transmit the unique ID to the mobile device include instructions to:
signal the mobile device to store the unique ID in a unit of the local memory of the mobile device that is not modifiable by a user of the mobile device without uninstalling the operating system associated with the mobile device.

15. The computer-readable medium of claim 12, wherein the unique ID associated with the mobile device comprises:
an indication of the operating system associated with the mobile device;
an indication of the manufacturer associated with the mobile device;
an indication of a field type of the first identifier or the second identifier; and
the first identifier or the second identifier.

16. The computer-readable medium of claim 15, wherein the field type is one of a serial number, an International Mobile Station Equipment Identity (IMEI) number, a Mobile Equipment Identifier (MEID) number, a unique device identifier (UDID), or a universally unique identifier (UUID).

17. The computer-readable medium of claim 12, further storing instructions for the one or more computers to:
select the first identifier from a set of available identifiers of the mobile device based an order for the set of available identifiers, the order being based on the operating system of the mobile device.

18. The computer-readable medium of claim 12, further storing instructions for the one or more computers to:
receive, at the server, a request to access a data store, the request being coupled with the unique ID of the mobile device;
store the unique ID in a set of unique IDs permitted to access the data store; and
provide, to the mobile device having the unique ID, permission to access the data store.

19. The computer-readable medium of claim 12, further storing instructions for the one or more computers to:
receive, at the server, a request to register the mobile device with the server; and
register the mobile device with the server using the unique ID associated with the mobile device.

20. A system comprising:
one or more processors;
a network interface; and
a memory storing instructions which, when executed by the one or more processors, cause the one or more processors to:
receive, at a server in a mobile communication network, using the network interface, a set of characteristics associated with a mobile device, the set of characteristics identifying an operating system associated with the mobile device and a manufacturer associated with the mobile device;
determine whether the set of characteristics also includes a first identifier associated with the mobile device, the first identifier being an intrinsic or predefined value associated with the mobile device and uniquely identifying the mobile device among mobile devices associated with a same operating system and a same manufacturer as the mobile device;
upon determining the set of characteristics includes the first identifier, generate a unique identifier (ID) for the mobile device based on the operating system associated with the mobile device, the manufacturer associated with the mobile device, and the first identifier associated with the mobile device;
upon determining the set of characteristics does not include the first identifier, obtain a second identifier associated with the mobile device and generating the unique ID based on the operating system of the mobile device, the manufacturer of the mobile device, and the second identifier; and
store the unique ID associated with the mobile device.
